(19) United States
(12) Patent Application Publication
(10) Pub. No.: US 2002/0169662 A1
(43) Pub. Date: Nov. 14, 2002

(54) System and method for aggregating and distributing electronic coupons

(75) Inventor: Anthony Claiborne, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: InfoSpace, Inc.

(21) Appl. No.: 09/853,286

(22) Filed: May 10, 2001

(51) Int. Cl. G06F 17/60

(52) U.S. Cl. 705/14; 707/3; 707/6

(57) ABSTRACT

A system and method for receiving, distributing, and exchanging electronic discount coupons over a computer network such as the Internet. The system comprises a plurality of client computers, a coupon server, an honoring server and an issuing server. In one embodiment, the coupon server receives a plurality of electronic coupons for storage in a database. The coupon server transmits data indicative of a description of at least one electronic coupon to at least one client computer, and then receives a signal indicative of a selection of at least one electronic coupon. In response to the request, the coupon server performs an exchange of electronic coupons, wherein the exchange includes the receipt of data representing a new electronic coupon from one client computer in trade for a transmission of data representing the selected electronic coupon.

### FIELD OF THE INVENTION

The present invention relates to electronic commerce systems and, in particular, the present invention relates to a system and method for aggregating and distributing electronic coupons via a distributed computing network.

### BACKGROUND OF THE INVENTION

Discount coupons have long been distributed by manufacturers, retailers, and other business entities to encourage consumers to buy sale items. Traditionally, advertisers have issued printed coupons that a consumer can take to a redemption center, such as a retail store, and redeem for a discount toward the purchase price of a product or service.

With the advent of the Internet, systems have also been created to distribute electronic coupons that allow retailers to offer discounts on items available from e-commerce World Wide Web (“WWW” or “Web”) sites. According to these systems, electronic coupons are offered by retailers through the use of electronic mail (“e-mail”) messages sent to consumers, or by the display of a hypertext link that leads to a Web page that displays the electronic coupon. While these systems are effective for mass distribution of electronic coupons, there are also several disadvantages. In particular, coupons for desired products are often unavailable or difficult to find using these types of systems.

In one previous system for distributing electronic coupons, a consumer that makes a purchase from a first Web site selling particular products may receive an electronic coupon good toward a discount on a different type of product sold at a second Web site. For instance, a consumer purchasing books at a first Web site may receive an electronic coupon good toward the purchase of clothing at a second Web site. This type of electronic coupon is called a reciprocal electronic coupon and has become increasingly popular among e-commerce merchants. However, reciprocal electronic coupons are also not without their drawbacks. For instance, although a consumer may receive a reciprocal electronic coupon good for a discount at a clothing Web site, the consumer may not be interested in purchasing a clothing item from the second Web site. This mismatch of interest greatly reduces the value of the received electronic coupon. In some cases, the consumer is highly unlikely to utilize the reciprocal electronic coupon.

A similar mismatch in consumer interest may also arise where electronic coupons are distributed in bulk through e-mail systems. For instance, an e-commerce merchant may utilize an e-mail address database to distribute literally millions of electronic coupons via e-mail. Although such systems are useful for mass distribution, they do little to target consumers' specific purchasing needs. Accordingly, the majority of the electronic coupons sent via e-mail will go unredeemed.

Accordingly, in light of the above problems, there exists a need for a system and method for aggregating and distributing electronic coupons that allows a consumer to redeem an unwanted electronic coupon for a desired electronic coupon. In addition, there exists a need for a system and method for aggregating and distributing electronic coupons that can increase the redemption rate of reciprocal electronic coupons and bulk distributed electronic coupons.

### SUMMARY OF THE INVENTION

The present invention addresses the above-identified needs by providing a system and method for aggregating and distributing electronic coupons that allows consumers to exchange unwanted electronic coupons for desired electronic coupons. Through the use of the system and method provided herein, the redemption rate of reciprocal electronic coupons or bulk distributed electronic coupons may be advantageously increased.

In one embodiment, the system comprises one or more client computers, a coupon server, an honoring server and an issuing server. In this illustrative embodiment, the honoring server functions as an e-commerce Web site and is associated with a business entity offering the sale of products or services. The honoring server is configured to receive electronic coupons good for discounts on purchases transacted at the e-commerce Web site. The issuing server functions as a Web server, e-mail server, or the like, and is configured to distribute electronic coupons for discounts on commerce items. The coupon server functions as an intermediate contact between the issuing server and the honoring server and is configured to communicate with the client computers to transmit, receive and store electronic coupons.

In one embodiment, the coupon server provides a Web site for aggregating and distributing electronic coupons. The coupon server receives a plurality of electronic coupons and stores the electronic coupons in a database. When a user possessing a new electronic coupon utilizes a client computer to visit the Web site provided by the coupon server, the coupon server transmits a description of at least one electronic coupon stored in the database to the client computer. The user of the client computer may then select one or more of the described electronic coupons and request the transmission of the coupon. In response to the request, the coupon server performs an exchange of electronic coupons, wherein the exchange includes the receipt of the new electronic coupon from the client computer in exchange for the selected electronic coupon.

According to another actual embodiment of the present invention, the coupon server is operative to store a database of electronic coupons. The coupon server is also operative to provide a Web site for aggregating and distributing electronic coupons, including reciprocal coupons, e-mail coupons, and other types of electronic coupons. Users who wish to join the Web site agree to donate their unused electronic coupons to the Web site. The users may thereafter transmit electronic coupons to the Web site which are stored in the database by the coupon server. In exchange for donating their electronic coupons to the Web site, users are provided access to electronic coupons donated by other users. Users may request and obtain electronic coupons from the coupon server and then utilize the received coupons to make purchases. If another coupon results from the purchase, the resulting coupon may also be donated to the Web site provided by the coupon server.

According to yet another actual embodiment of the present invention, the aggregation and exchange of coupons takes place between networked peer computers. Software resident on a user's computer allows the user to present coupons for exchange with other users of networked peer computers running enabling software. The user possessing an electronic coupon for exchange may exchange that coupon from the user's computer for a desired coupon resident on a remote peer computer. The invention enables the exchange of these coupons so that the desired coupon becomes resident on the user's computer and the coupon exchanged by the user becomes resident on a remote peer computer. A coupon thus exchanged may be utilized for purchases by the user of the remote peer computer upon which the coupon now resides. In the alternative, such a coupon may be further exchanged by the user in accordance with the teachings of the present invention.

The present invention also provides a computer-readable medium and a computer-controlled apparatus for aggregating and distributing electronic coupons.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram showing a plurality of computing devices connected to a network for providing coupon aggregation and exchange services in accordance with the present invention;

FIG. 2 is a block diagram illustrating an architecture of a client computer utilized in an actual embodiment of the present invention;

FIG. 3 is a block diagram illustrating an architecture for an honoring server utilized in an actual embodiment of the present invention;

FIG. 4 is a block diagram illustrating an architecture of an issuing server utilized in an actual embodiment of the present invention;

FIG. 5 is a block diagram illustrating the architecture of a coupon server utilized in an actual embodiment of the present invention;

FIG. 6 is a screen diagram of an illustrative Web page for entering electronic coupon information for submission to an honoring server;

FIG. 7 is a screen diagram of an illustrative Web page for sending an electronic coupon to a coupon server;

FIG. 8 is a screen diagram of an illustrative Web page for locating a desired electronic coupon stored on a coupon server;

FIG. 9 is a screen diagram of an illustrative Web page for selecting an electronic coupon from a menu describing a plurality of electronic coupons;

FIG. 10 is a screen diagram of an illustrative Web page for confirming an exchange of a user provided electronic coupon and an electronic coupon available from a coupon server;

FIGS. 11A-11B are flow diagrams illustrating a routine for displaying and exchanging electronic coupons with a coupon server according to an actual embodiment of the present invention;

FIG. 12 is a flow diagram illustrating a routine for exchanging electronic coupons in a network environment having a semi-distributed database architecture stored on a plurality of peer computers; and

FIG. 13 is a flow diagram illustrating a routine for exchanging electronic coupons in a network environment having a fully-distributed database architecture stored on a plurality of peer computers.

### DETAILED DESCRIPTION OF THE PREFERRED EMBODIMENT

The present invention is directed to a computer-implementable method for aggregating and distributing electronic coupons over a computing network, such as the Internet. This system comprises one or more client computers, a coupon server, an honoring server and an issuing server. In one embodiment, the issuing server issues electronic coupons to users of the client computer in the form of an e-mail message or a Web page. The coupon server provides a Web site at which users of the client computers may donate and exchange the electronic coupons they have received. In this embodiment, the Web site provided by the coupon server functions as a repository for electronic coupons and stores the electronic coupons in a database having search capabilities.

When a user visits the Web site, the user may donate their electronic coupons. In exchange for such a donation, the user may be permitted to search the available coupons and download one or more desired electronic coupons from the database. The user may then utilize the received electronic coupon at a Web site provided by the honoring server to obtain a discount on goods or services.

In one embodiment of the present invention, a user may request a list of the available coupons from the coupon server. The coupon server then transmits a description of the coupons to the client computer where the description is displayed to the user. In another embodiment, a user may search the database of electronic coupons for a desired product or service. In response, the user may receive a description of the electronic coupons stored in the database and matching the user's search query. Once the user locates a desired electronic coupon, the user can select the coupon and receive the selected electronic coupon from the coupon server in exchange for a new electronic coupon provided by the user. The coupon server may also verify the validity of the user-provided electronic coupon. Referring now to the figures, in which like numerals represent like elements, an actual embodiment of the invention will be disclosed.

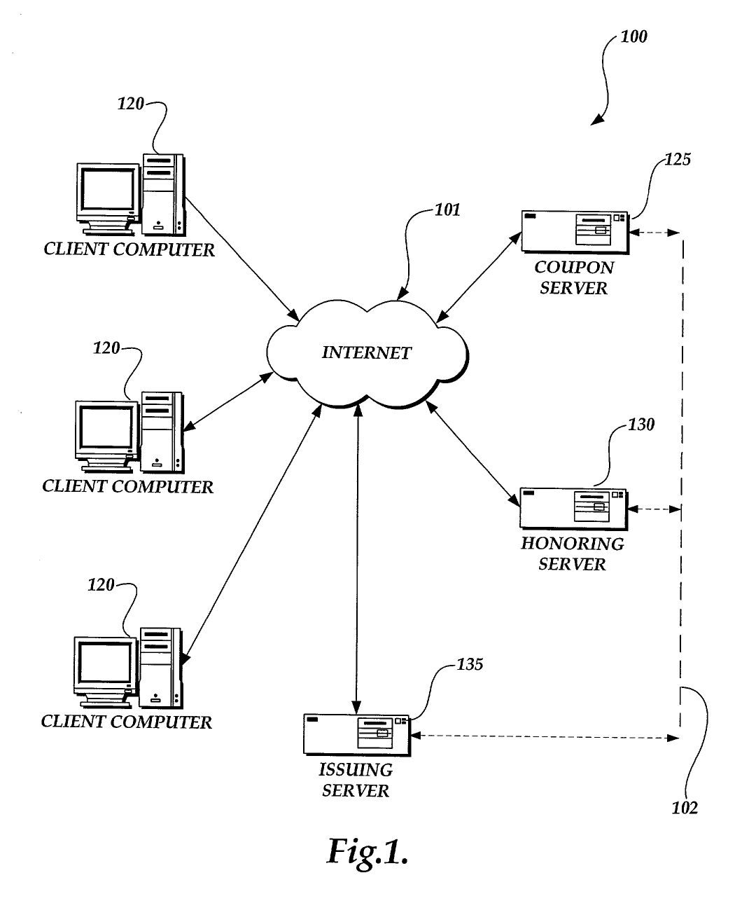

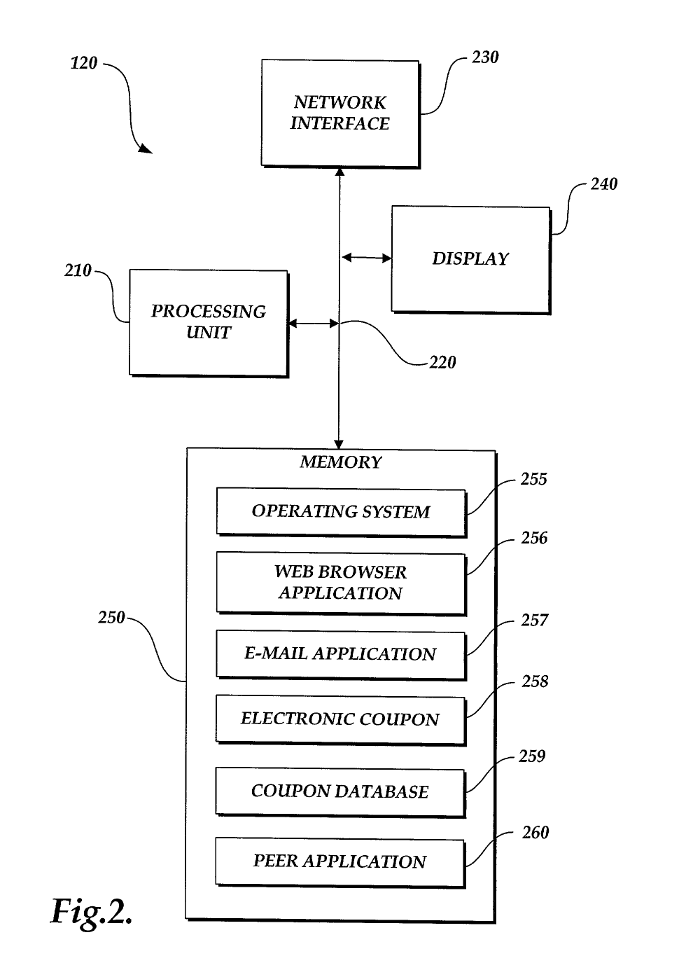

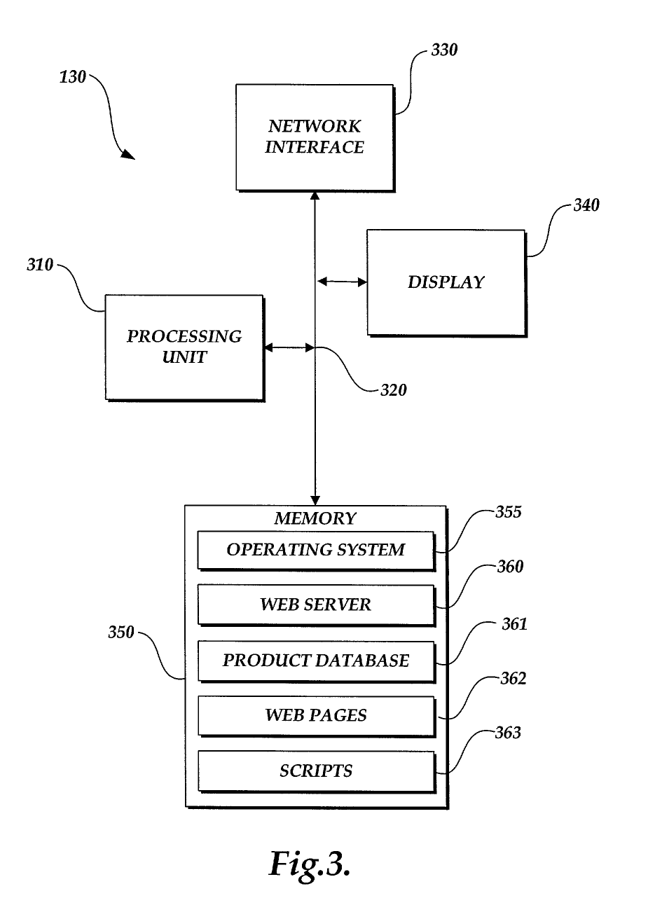

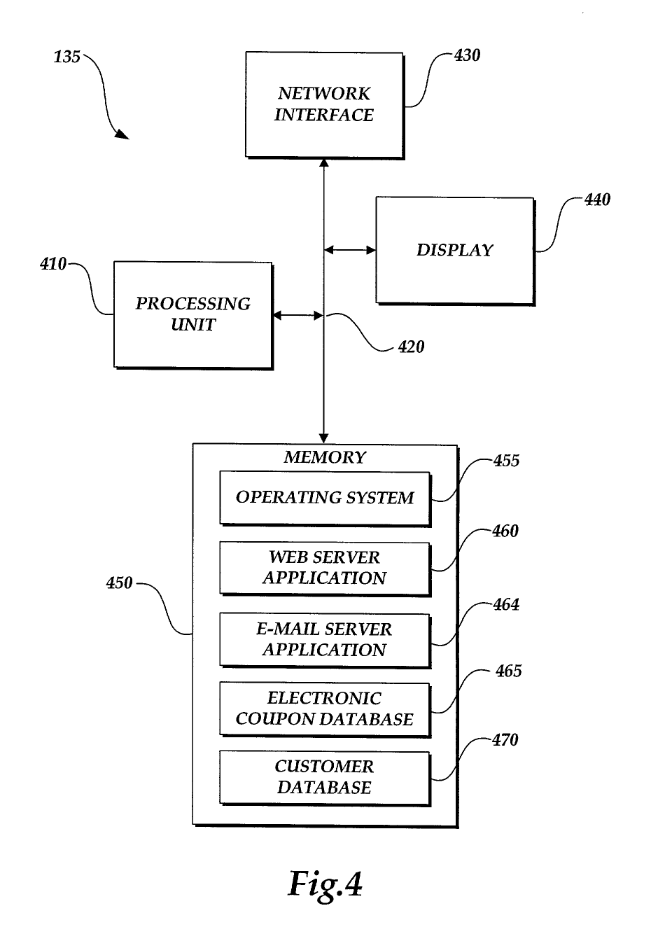

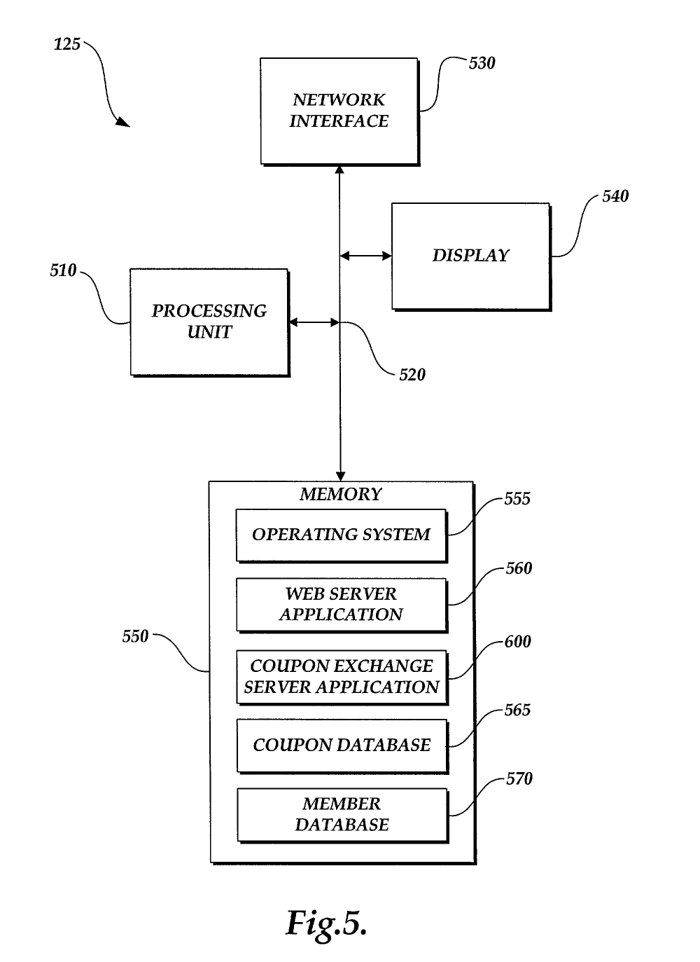

Referring to FIG. 1, the following discussion is intended to provide an exemplary overview of one suitable computing environment in which the invention may be implemented. Generally described, the computing environment may comprise a plurality of client computers 120, a coupon server 125, an honoring server 130, and an issuing server 135. Each computing device depicted in FIG. 1 is configured to electronically communicate via a network such as the Internet 101. In addition, the coupon server 125, honoring server 130, and the issuing server 135 may be controlled by one business entity and thus also configured to electronically communicate via a local area network (“LAN”) 102. The client computers 120 will be described in greater detail below with respect to FIG. 2. The honoring server 130 will be described in greater detail below with respect to FIG. 3. The issuing server 135 will be described below with respect to FIG. 4. The coupon server will be described below with respect to FIG. 5. It should be appreciated that the illustrative embodiment shown in FIG. 1 is one suitable computing environment for the present invention and that the methods described below may be implemented in any computing environment. For instance, the competing environment of FIG. 1 may be configured on an intranet, thereby limiting the computing devices to a closed system.

As known to one of ordinary skill in the art, the term “Internet” refers to a collection of networks and routers that use the Internet protocol (“IP”) to communicate with one another. As known to one having ordinary skill in the art, the Internet 101 generally comprises a plurality of LANs and wide-area networks (“WANs”) that are interconnected by routers. Routers are special purpose computers used to interface one LAN or WAN to another. Communication links within the LANs may be twisted pair wire, or coaxial cable, while communication links between the WANs may be optical links. As also known to one having ordinary skill in the art, the Web is a vast collection of generally interconnected hypertext documents, electronically stored on server computers connected to the Internet 101.

Referring now to FIG. 2, an illustrative computer architecture for implementing a client computer 120 in accordance with one aspect of the present invention will be described. Those of ordinary skill in the art will appreciate that the client computer 120 may include many more components than those shown in FIG. 2. However, it is not necessary that all of these generally conventional components be shown in order to disclose an illustrative embodiment for practicing the present invention. As shown in FIG. 2, the client computer 120 includes a network interface 230 for connecting to the Internet 101. Those of ordinary skill in the art will appreciate that the network interface 230 includes the necessary circuitry for such a connection, and is also constructed for use with the TCP/IP protocol.

The client computer 120 also includes a processing unit 210, a display 240, and a memory 250. The memory 250 generally comprises a random access memory (“RAM”), a read-only memory (“ROM”) and a permanent mass storage device, such as a disk drive. The memory 250 stores the program code necessary for operating the client computer 120 and for providing a user interface on the display 240. In addition, the memory 250 stores a Web browser application 256, such as NETSCAPE NAVIGATOR® or MICROSOFT INTERNET EXPLORER®. The Web browser application 256 is utilized by a user of the client computer 120 to access information available via the Internet 101. The client computer 120 may also comprise an e-mail application 257 for sending and receiving e-mail messages via the Internet 101. The client computer 120 may also store one or more electronic coupons. As will be described in greater detail below, these coupons may be received at the client computer 120 from the issuing server or the coupon server. It will be appreciated that these software components may be loaded from a computer-readable medium into memory 250 of the client computer 120 using a drive mechanism associated with the computer-readable medium, such as a floppy, tape or CD-ROM drive (not shown), or via the network interface 230.

Although an illustrative client computer 120 has been described that generally conforms to a conventional general purpose computing device, those of ordinary skill in the art will appreciate that the client computer 120 may comprise any number of devices capable of communicating with a network such as the Internet 101 or with a Web server, such as the coupon server 125. For example, the client computer 120 may comprise a two-way pager, a cellular phone, a personal data assistance (“PDA”), or the like.

Referring now to FIG. 3, an honoring server 130 utilized in an actual embodiment of the present invention will be described. In one embodiment of the present invention, the honoring server 130 is associated with a business entity such as a retailer or any other service provider offering commerce items for sale over the Internet. The honoring server 130 is configured to provide users with a list of commerce items and execute sales transactions of the commerce items. The honoring server 130 is also configured to accept electronic coupons for providing discounts on the commerce items sold through the honoring server 130.

Those of ordinary skill in the art will appreciate that the honoring server 130 includes many more components than those shown in FIG. 3. However, it is not necessary that all of these generally conventional components be shown in order to disclose an illustrative embodiment for practicing the present invention. As shown in FIG. 3, the honoring server 130 comprises a network interface 330 that is used to electronically communicate with a network such as the Internet. Those of ordinary skill in the art will appreciate that the network interface 330 includes the necessary circuitry for connecting the honoring server 130 to the Internet 101, and is constructed for the use with a communication protocol such as TCP/IP protocol.

The honoring server 130 also includes a processing unit 310, a display 340, and a mass memory 350, all interconnected along within the network interface 330 via a bus 320. The mass memory 350 generally comprises RAM, ROM, and a mass storage device such as a hard disk drive. The mass memory 350 stores the program code in data necessary for providing an e-commerce Web site at which goods or services may be purchased and at which electronic coupons will be honored. To provide such functionality, the mass memory 350 stores a product database 361 for storing descriptions, prices, pictures, and other information regarding the commerce items to be sold via the honoring server 130. In addition, the mass memory 350 also comprises an operating system 355 configured to operate and control the functionality of the honoring server 130, such as Windows NT® from Microsoft Corporation. The mass memory 350 also stores a Web server application 360 for serving up the Web pages 362 that comprise the e-commerce Web site. The Web server application 360 may also include scripts 363 or other program code for processing electronic coupons. It will be appreciated that the aforementioned software components may be loaded from a computer-readable medium into the mass memory 350 of the honoring server 130 using a drive mechanism associated with the computer-readable medium, such as a floppy, tape, or CD-ROM drive (not shown) or via the network interface 330.

Referring now to FIG. 4, an issuing server 135 utilized in an actual embodiment of the present invention will be described. In one embodiment, the issuing server 135 may be associated with a business entity that issues and distributes electronic coupons. In another embodiment, the business entity associated with the issuing server 135 may also be associated with one or more honoring servers 130. The issuing server 135 is configured to distribute electronic coupons via e-mail or by the distribution of the electronic coupons via Web pages. It should also be appreciated that the functions of the issuing server 135 may be implemented on the same computing device as the honoring server 130 described above with respect to FIG. 3.

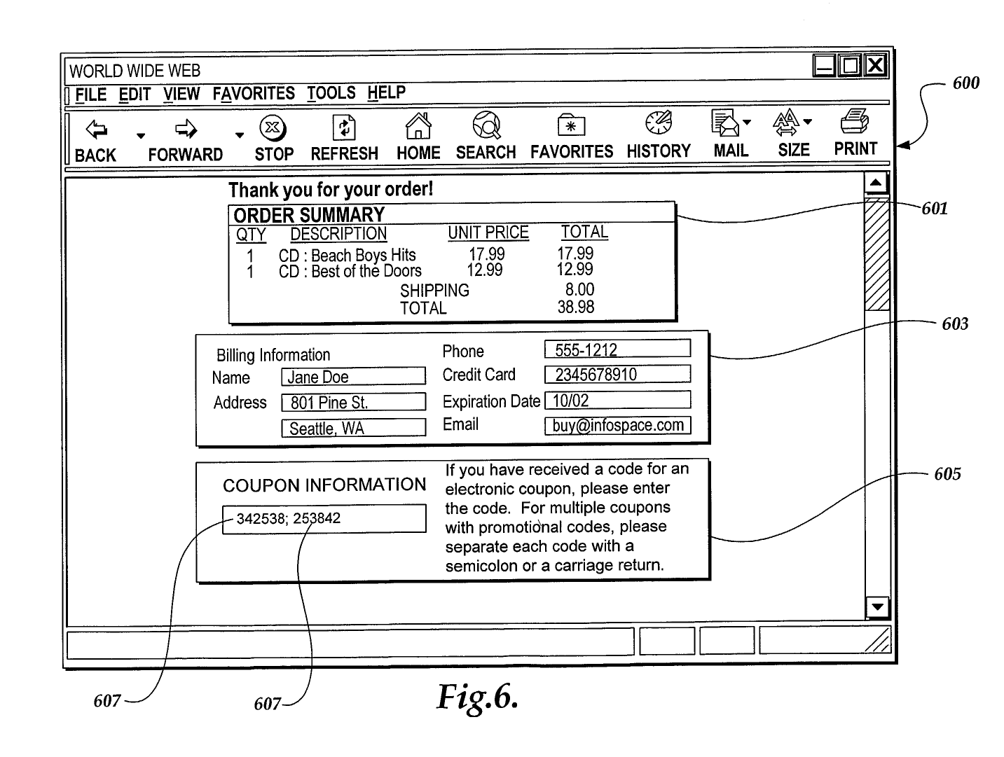

Electronic coupons may be provided by the issuing server 135 in several formats. For instance, an electronic coupon may be provided in the form of a numeric code that may be entered by a user into a Web page. Alternatively, an electronic coupon may be provided in the form of a Uniform Resource Locator (“URL”) that is associated with a specific Web page offering a discount by the use of an electronic coupon. Other types of electronic coupons will be described in more detail below with reference to FIGS. 6-9.

As shown in FIG. 4, the issuing server 135 comprises a network interface 430 for electronic communication with the Internet 101, a processing unit 410, a display unit 440, and a mass storage device 450. The components utilized to construct the issuing server 135 are similar to those of the honoring server 130 depicted in FIG. 3 and described above. Those of ordinary skill in the art will appreciate that the issuing server 135 includes many more components than those shown in FIG. 4. However, it is not necessary that all of these general components be shown in order to disclose an illustrative embodiment for practicing the present invention.

The mass memory 450 of the issuing server 135 comprises an operating system 455 for controlling the functionality of the issuing server 135 and executing the software applications stored on the issuing server 135, such as the Web server application 460 and the e-mail server application 464. The issuing server 135 also includes a coupon database 465 for storing a plurality of electronic coupons, and a customer database 470 for storing customer contact information. The customer database 470 comprises information regarding the e-mail addresses or other customer contact information and is used by the issuing server 135 to distribute the electronic coupons stored in the coupon database 465. As described above, the electronic coupons stored in the coupon database 465 may be distributed to customers identified in the customer database 470 by either the Web server application 460 or the e-mail server application 464.

Referring now to FIG. 5, a coupon server 125 utilized in one embodiment will be described. In one illustrative embodiment of the present invention, the coupon server 125 provides an Internet Web site operative to aggregate and distribute electronic coupons. In this illustrative embodiment, the coupon server 125 comprises the program code and data necessary for receiving, processing, and transmitting electronic coupons with a plurality of network computers. Generally described, the coupon server 125 is configured with software applications for storing a plurality of electronic coupons in a database and providing descriptions of the plurality of coupons to users of client computers of the Internet. The coupon server also comprises a software application configured to allow users of client computers to exchange new electronic coupons for electronic coupons stored in the memory of the coupon server 125.

Those of ordinary skill in the art will appreciate that the coupon server 125 includes many more components than those shown in FIG. 5. However, it is not necessary that all of these general conventional components be shown in order to disclose an illustrative embodiment for practicing the present invention. As shown in FIG. 5, the coupon server 125 is electronically connected to the Internet 101 via a network interface 530. Those of ordinary skill in the art will appreciate that the network interface 530 includes the necessary circuitry for connecting the coupon server 125 to the Internet 101, and is constructed for the use with any Internet protocol such as TCP/IP.

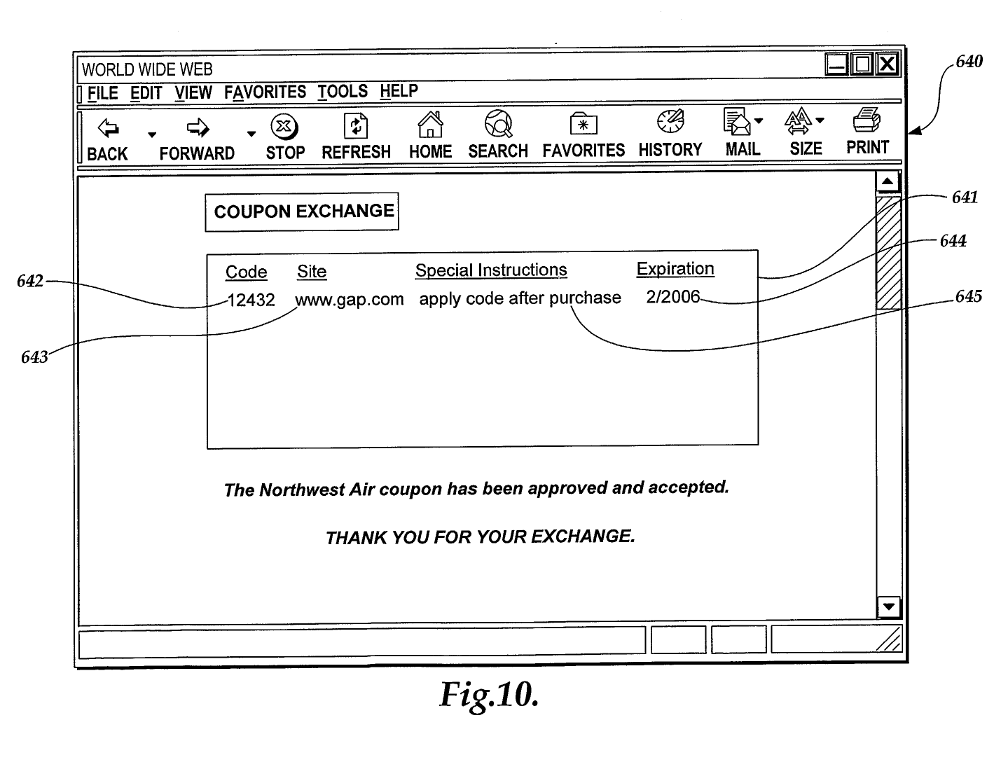

The coupon server also includes a processing unit 510, a display 540, and a mass memory 550, which are all interconnected with the network interface 530 via a bus 520. In this exemplary embodiment, the mass memory 550 generally comprises RAM, ROM, and one or more permanent mass storage devices such as a hard disk or hard disk drive, tape drive, optical drive, floppy disk drive or a combination therefore. The mass memory 550 stores the program code for receiving, storing, and exchanging electronic coupons in accordance with the present invention. More specifically, the mass memory 550 stores a coupon exchange server program 600, which comprises a routine which is further described below with reference to FIGS. 10A-10B. In addition, the mass memory 550 stores the electronic coupons in a coupon database 565, a Web server application 560 and a member database 570. The member database 570 stores a plurality of user data for efficiently transferring the electronic coupons to targeted users of the Internet. The coupon database 565 comprises a plurality of electronic codes representative of electronic coupons for providing discounts of commerce items of the Internet. As described in more detail below, the coupon database may be in many forms and/or formats and configured to receive new electronic coupons and for storing a plurality of coupons in a permanent computer-readable medium.

In this exemplary embodiment, the mass memory 550 stores a Web server application 560 for handling requests of users to receive the stored information of the coupon and customer database 565 and 570. It will be appreciated that the aforementioned software components may be loaded from a computer-readable medium into the mass memory 550 for the coupon server 125 using a drive mechanism associated with a computer-readable medium, such as a floppy, tape, or CD-ROM drive (not shown) or via the network interface 530. It will also be appreciated by those of ordinary skill in the art that the coupon database 565 may be stored in any conventional retrievable format such that the electronic coupons may be accessed and/or modified by a client computer 120.

Aspects of the present invention utilize electronic coupons commonly used for providing consumers with discounts and rebates on commerce items and services sold over electronic commerce systems. As known to one having ordinary skill in the art, an electronic coupon may be in a variety of formats such as alpha-numeric codes, HTML links, graphics image files, such as PDF files, and or any other electronic hard-copy format that represents a certificate that may be redeemed by a consumer for a discount, rebate, or the like. In one example, an electronic coupon may be in the form of an alpha-numeric or numeric code that may be generated and transmitted from a Web server, such as the issuing server 135 of FIG. 1. In this exemplary embodiment of an electronic coupon, the issuing server 135 may generate a code for a discount of a particular product that may be sold from an honoring server 130. For example, an electronic coupon represented by a numeric code that is generated by the issuing server 135, wherein the numeric code would identify, in an encrypted format, information regarding the type of discount and type of product associated with the discount. The encrypted numeric code may also describe the Web servers at which the electronic coupon can be redeemed. Once an electronic coupon code is generated from the issuing server 135, the issuing server 135 can distribute the electronic coupon by the use of a number of mediums. For instance, the electronic coupon code can be printed on a postcard or paper document for distribution of the electronic coupon via retail sales of the commerce items.

In another example, an electronic coupon can be in the form of a text code or a character string that can be electronically transmitted to users via known communication mediums such as email, instant messaging or the like. In yet another example, an electronic coupon can be in the form of a universal resource locator (URL), which can also function as a hypertext link in an email or can be distributed by the placement of the URL into another Web page of a retailer or commerce entity.

Referring now to FIG. 6, aspects of an exemplary electronic coupon will be described. The screen shot illustrated in FIG. 6 is one example of an e-commerce Web page 600 that is configured to receive an electronic coupon code. As illustrated in FIG. 6, a typical e-commerce Web page may be configured to sell commerce items such as compact disks or other like products. With reference to FIG. 1, such a typical e-commerce Web page 600 may be offered by a server such as the honoring server 130.

As known, typical commerce Web sites allow a user to select desired commerce items. In the exemplary embodiment shown in FIG. 6, a Web server may generate a an e-commerce Web page 600 containing an order summary field 601 that describes products selected by a consumer and a price summary of each item. The e-commerce Web page 600 may also include a billing information field 603 for the consumer to enter their contact and billing information. In addition, the Web page 600 may also comprise a data entry field 605 for a user to enter electronic coupon codes 607. In this example, the Web page 600 also comprises text that describes the type of electronic coupon accepted by the Web server and instructions for entering the codes. The data entry field 605 may comprise several embodiments, one of which can be a HTML text field configured to accept numeric codes, such as those shown as items 607. In another example, the electronic coupon codes may be in the form of a URL or a link to another HTML Web page. Once the user completes each data field 601, 603, and 605, the Web server issuing the e-commerce Web page 600 executes the sales transaction as specified by the user. The electronic coupon, which is represented by a numeric coupon code 607, is utilized in the sales transaction to provide the user with a discount on the purchased items.

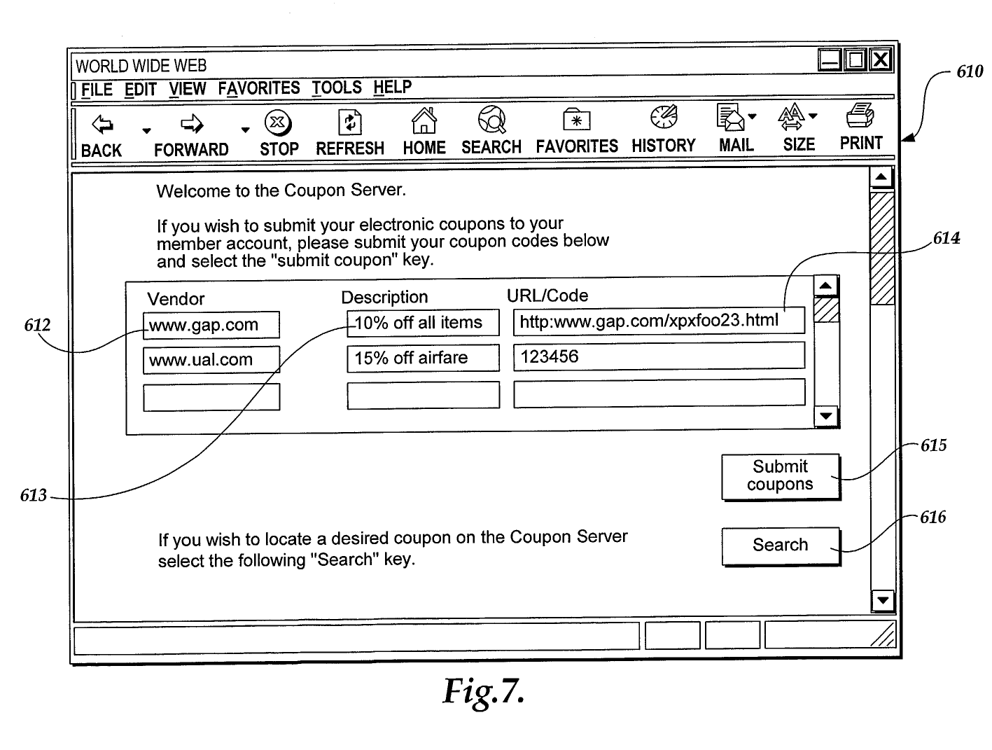

As known to one of ordinary skill in the art, an electronic coupon can be distributed by a Web server or any other computing device by an electronic email that is configured with user names and email addresses of customer databases, as shown in the customer database 470 of the issuing server 135. Referring again to FIG. 1, an issuing server 135 can multicast an electronic coupon to a plurality of client computers 120 via e-mail. Each user of the various client computers 120 can utilize the received electronic coupon to purchase a product at the one or more honoring servers 130. However, if the user does not wish to purchase the item specified in the electronic coupon, the value of the electronic coupon is greatly diminished. In accordance with one aspect of the present invention, a recipient of an electronic coupon who does not wish to purchase the product specified in the electronic coupon can exchange their electronic coupon for a new electronic coupon granting a discount on a desired product. This process of a coupon exchange is described in more detail below with reference to FIGS. 7-10.

In one embodiment, the coupon server 125 is configured to store a database of electronic coupons. The coupon server 125 is also configured with a member database for the storage of user data. This configuration allows users to join the Web site as members where the coupon server 125 maintains an account balance for each member. In this embodiment, each member may submit one or more electronic coupons to the coupon server 125 to increase the balance of their account. As each electronic coupon is received from the members, the coupon server stores the electronic coupons in the electronic coupon database 465. The coupon server 125 then allows the members to locate and receive electronic coupons stored in the electronic coupon database 465. Once the member locates and selects one or more of the desired electronic coupons, the coupon server 125 transmits the desired electronic coupon to the member and appropriately decreases the balance of the account associated with the member. In another aspect of the present invention, the coupon server 125 is configured to allow users to execute an exchange of electronic coupons. In this embodiment, the coupon server 125 allows a user to submit a new electronic coupon to the coupon server 125 in exchange for an electronic coupon selected by the user.

Referring now to FIGS. 7-10, representative screen shots of the actual embodiment of the present invention for allowing consumers to locate, transmit and receive electronic coupons is illustrated and described below. The screen shots in FIGS. 7-10 are generated by the computing devices shown in FIG. 1 and displayed in a Web page window 610, 620, 630, and 640 generated by a Web browser application 256 executing on a client computer 120.

In one exemplary embodiment, a user of a client computer 120 will access the coupon server 125 via a Web browser application executing on the client computer 120. The coupon server 125 will respond to the client computer by transmitting a Web page that allows a user to logon to the coupon server 125. In this embodiment, the coupon server 125 maintains a database comprising customer login information and data relating to an account balance for monitoring the number of electronic coupons exchanged between the coupon server 125 and the user. The coupon server 125 then allows the user to transmit and receive electronic coupons to and from the coupon server 125. Generally described, when the user transmits an electronic coupon to the coupon server 125, the server credits the account associated with the user. When the user receives an electronic coupon from the coupon server 125, the server then debits the account associated with the user. This embodiment also includes database search capabilities that allow the user to search for desired electronic coupons. Accordingly, the system allows users to receive desired electronic coupons while providing them with an incentive to provide electronic coupons for the coupon database 565 of the coupon server.

With respect to another aspect of the invention, the coupon server 125 allows for a direct exchange of electronic coupons between the user and the coupon server 125. In this process, the user can execute a search on the coupon server 125 to locate a desired electronic coupon. When the coupon server 125 conducts a search for desired electronic coupons for the user, the coupon server 125 then transmits information describing a plurality of electronic coupons that are stored in the coupon database 565. The user will then be prompted to offer an electronic coupon to the coupon server 125 in exchange for the desired electronic coupon received by the user.

The above-described embodiments allow the coupon server 125 to function as an intermediary server between the honoring server 130 and the issuing server 135, as the user may submit a first electronic coupon received from the issuing server 135 in exchange for a second coupon for a discount at a merchant associated with an honoring server 137.

Referring now to FIG. 7, a Web page 610 configured to allow a user to submit an electronic coupon to the coupon server 125 will be described. It can be appreciated by one skilled in the art that a Web browser application 256 will be utilized for requesting the Web page 610 displayed in FIG. 7. It can also be appreciated by one skilled in the art that the Web page 610 may be transmitted to a client computer 120 after the user has logged into the coupon server 125, thereby creating a direct association between the user of the client computer 120 and an account established at the coupon server 125.

Once the coupon server 125 receives a request for the Web page 610, the coupon server 125 transmits the Web page 610 and provides the user with an option to submit an electronic coupon to the coupon server 125. The Web page 610 also provides the user with an option to conduct a search for another desired electronic coupon. As shown in FIG. 7, the Web page 610 is configured to receive codes that represent an electronic coupon. More specifically, the Web page 610 is configured with a plurality of text entry fields 612, 613, and 614 to allow the user of the client computer 120 to enter information related to the electronic coupon for submission to the coupon server 125. To submit an electronic coupon to the coupon server 125, the user enters the vendor information in the vendor text field 612, such as a vendor Web site www.gap.com. Next, the user may enter a text description of the electronic coupon in the description field 613. For instance, the user may enter text in the description field 613 that describes an electronic coupon offering a 10% discount on all items offered by the vendor. The Web page 610 is also configured to receive a code that represents the electronic coupon. In this example, the electronic coupon may be in the form of a URL such as http:www.gap.com/xpxf0023.html. Although an electronic coupon having a format of a URL code is used in this example, it can be appreciated by one of ordinary skill in the art that an electronic coupon may be in any format. Accordingly, the Web page 610 may be configured to receive a URL, an image file, or any other data representative of a coupon. Also shown in FIG. 7, the Web page 610 may be configured to receive a plurality of electronic coupons by the user for submission of a number of electronic coupons to the coupon server 125.

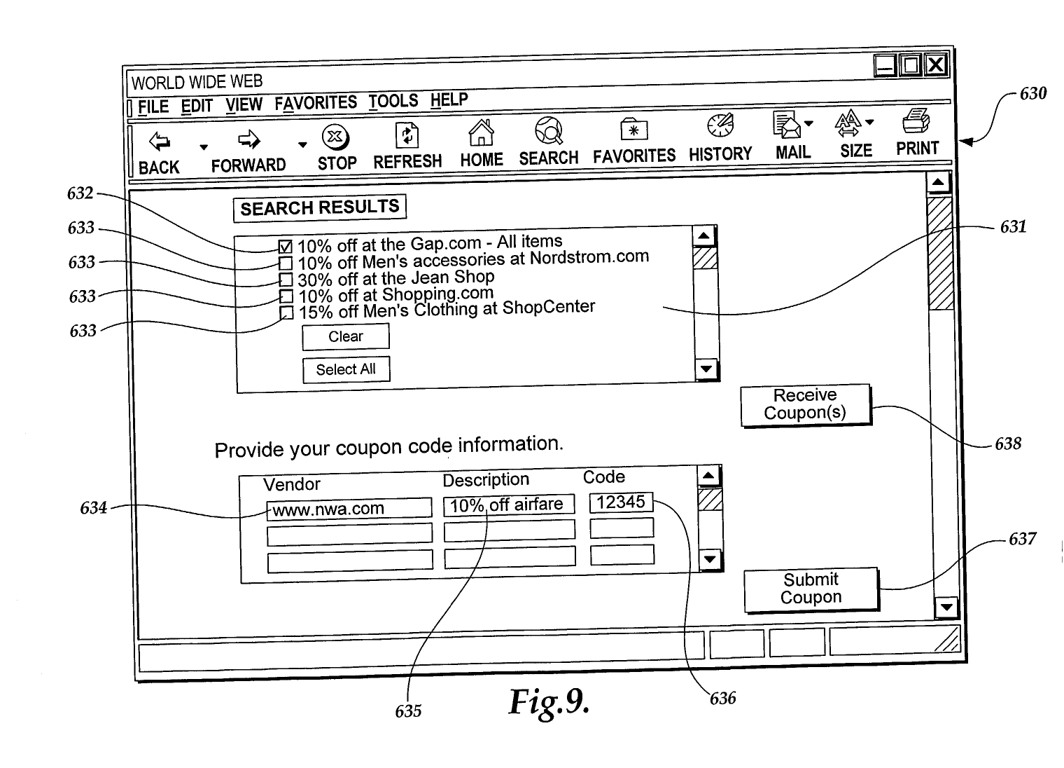

Once the coupon server 125 receives the codes that represent the electronic coupon, the server updates the user's account balance, thereby issuing credit for the coupon(s) submitted to the coupon server 125. As can be appreciated by one of ordinary skill in the art, an account balance can be incremented or decremented by the use of any unit of measurement. The method of the present invention may adopt any currently available accounting scheme to implement this process; however, it is desired that when a user submits an electronic coupon to the coupon server 125, the user's account is increased by an appropriate value that represents the type of coupon submitted to the coupon server 125. Upon receiving the electronic coupon information, the coupon server 125 performs a validation process to verify the validity of the electronic coupon entered by the user. The validation process is described in further detail below with reference to FIG. 9. Once a user has transferred their electronic coupons to the coupon server 125, the user may exit the session by actuating the “submit coupons” button 615.

Also shown in FIG. 7, the Web page 610 is configured with a menu option allowing a user to search for a desired electronic coupon. In this illustrative embodiment, the user may actuate the “search” button 616 to instruct the coupon server 125 to transmit a Web page that allows a user to search for an electronic coupon.

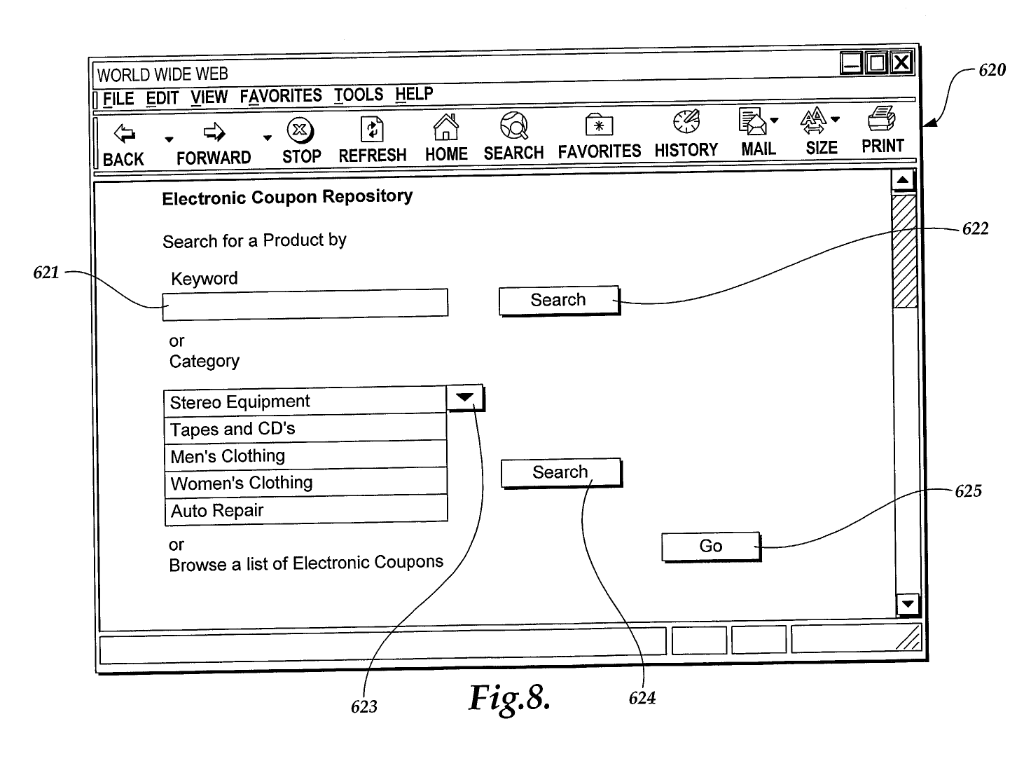

Referring now to FIG. 8, a Web page 620 configured to allow a user to search for desired electronic coupons on the coupon server 125 will be described. In this process, the coupon server 125 transmits the Web page 620 and provides the user with several options to search for a desired coupon. In this exemplary embodiment, the Web page 620 displays three options in searching for desired coupons. As shown in FIG. 8, the first option allows a user to search for a desired coupon by the utilization of a keyword. In this example, the Web page 620 is configured with a text entry field 621 for receiving text from the user. As can be appreciated by one skilled in the art, the user executes a search by entering a word related to a coupon of interest and then actuates the first “search” button 622. In response to receiving the signal to search for a keyword search, the coupon server 125 executes a database query in the coupon database 465 for coupons related to the keyword. As known by one of ordinary skill in the art, keyword search algorithms utilizing keywords can be configured in many different ways; therefore, search algorithms are not described in further detail herein.

Another way for the user to search for electronic coupons in the coupon database 465 of the coupon server 125 involves the utilization of predetermined categories that divide the electronic coupons into logically related groups. As shown in FIG. 8, the user can search for desired electronic coupons by the use of an HTML pull-down menu or any other like graphical user interface for selecting various categories. The Web page 620 is configured with an HTML pull-down menu 623, which allows a user to select at least one product category. If the user desires to search for electronic coupons using the search category method, the user selects one of the items, such as “auto repair,” and then actuates the second “search” button 624 to execute the category search. Although the exemplary embodiment of FIG. 8 illustrates five categories of electronic coupons on an HTML pull-down menu, this category search method may be executed on any other graphics user interface and can comprise many combinations of coupon categories. As known by one of ordinary skill in the art, general search algorithms utilizing subcategories of database elements is well known in the art.

Also shown in the Web page 620 of FIG. 8, another method of locating electronic coupons may involve an option for the user to request to view a large selection of electronic coupons stored in the coupon database 465 of the coupon server 125. In this method, the Web page 620 is configured with an instruction to the user indicating the user can access all of the electronic coupons in the coupon database 465. To execute this method, the user would simply actuate the “go” button 625 to receive another Web page displaying a plurality of coupon descriptions.

Although the exemplary embodiment of FIG. 8 illustrates three methods for searching for electronic coupons in the coupon database 465, the scope of the present invention also includes any other search method for allowing users to access database elements to find a desired electronic coupon. As known to one of ordinary skill in the art, any search algorithm may be applied to the present invention to carry out the above-described feature for allowing a user to locate a desired coupon.

Once the user executes a search algorithm for locating a desired electronic coupon, the user's client computer 120 transmits the search information to the coupon server 125. In response to receiving the search information, the coupon server 125 executes a database query in the coupon database 465 to locate the preferred electronic coupons. Once the coupon server 125 receives the database query results, the coupon server 125 transmits a Web page displaying the search results on the user's client computer 120.

Referring now to FIG. 9, an illustrated Web page for displaying a coupon database search result is described. The search result Web page 630 is configured with a text field 631 that displays the description of the electronic coupon found in the coupon database search. In this exemplary embodiment, each electronic coupon description is displayed with a radial button for allowing a user to select one or more of the displayed electronic coupons. For instance, if the user desires a particular electronic coupon offering a 10% discount at a desired retailer, the user would actuate the radial button 632 corresponding to the desired coupon.

As shown in FIG. 9, the search results Web page 630 is configured to only display a description of the electronic coupons found in the database search. This configuration allows the coupon server 125 to describe the nature of each electronic coupon without revealing the essential information that allows a user to redeem the electronic coupon. The essential information of a coupon may include information such as the actual coupon code or URL associated with the coupon. It is preferred that the search results Web page 630 only display a description of the electronic coupon, without the essential information, so that the user will only receive the coupon if their account is properly debited, or if they provide a coupon in trade for the received coupon. This method facilitates a quid pro quo feature that allows the coupon server 125 to maintain a large depository of electronic coupons while delivering electronic coupons to users having specific needs.

Once the user has selected all desired electronic coupons displayed in the search result Web page 630, the user may actuate the “receive coupons” button 638 to then receive the electronic codes associated with the selected electronic coupons. In this part of the process, the coupon server 125 then debits the user's account once they receive the electronic coupon. Also shown in FIG. 9, the search result Web page 630 may be configured to allow a user to submit an electronic coupon. This configuration of the Web page 630 allows a user to submit in an electronic coupon to the coupon server 125 to offer a coupon in trade or to increase the balance of their account.

Similar to the Web page of FIG. 7, the search result Web page 630 is configured with a plurality of text entry fields 634, 635, and 636 to allow a user of the client computer 120 to enter information related to the electronic coupon for submission to the coupon server 125. In this part of the process, the search result Web page 630 is configured with a text field to receive vendor information 634, a text field for receiving a description of the electronic coupon 635, and a text field for receiving the code 636 of the electronic coupon. In this illustrative embodiment, the vendor information field 634 includes a Web address for the honoring server associated with the coupon. In addition, the user enters text information to describe the nature of the electronic coupon. For instance, the description field 635 describes an electronic coupon offering a 10% reduction from the price of an airfare. The search result Web page 630 is also configured for receiving a code 636 that represents an electronic coupon. As described above, an electronic coupon may be in many formats, thus the Web page 630 may be configured to receive a URL, an image file, or any other data representative of a coupon.

Once the user has entered the information for the electronic coupon offered for exchange, the user actuates the “submit coupon” button 637. The actuation of the “submit coupon” button 637 instructs the Web browser application 256 to transmit the user information from the client computer 120 to the coupon server 125 for processing. Upon receiving the user information from the search result Web page 630, the coupon server 125 performs a validation process to verify the validity of the electronic coupon entered by the user.

It can be appreciated by one skilled in the art that a validation process may involve transmitting the electronic coupon information to a Web site of an honoring server, such as www.nwa.com, to verify the electronic coupon code received in the coupon code field. Upon receiving the coupon code, the honoring server may verify the coupon data with its own coupon database and then transmit data back to the coupon server 125 to verify the status of the coupon.

Once the coupon server verifies the validity of the electronic coupon received by the user, the coupon server 125 generates and transmits a verification Web page. As shown in FIG. 10, the verification Web page 640 includes a text field 641 that displays all of the essential information for the electronic coupon sent from the coupon server 125 to the user's client computer 120. The text field 641 includes the code that represents the electronic coupon 642, the Web address 643 for the honoring server (130 of FIG. 1), the expiration date of the electronic coupon 644 and a text field 645 that may include special instructions to allow the user to redeem the electronic coupon. Once the verification Web page 640 is received by the user, the user can then use the electronic coupon at their desired retailer.

With regard to another aspect of the present invention, the coupon server 125 may also be configured process the coupon code to remove any specific user information. Essentially, this process of “scrubbing” an electronic coupon may involve a step of removing specific user information in the code. For instance, if a first user receives an electronic coupon from a particular vendor such as Amazon.com, the code representing the electronic coupon may incorporate information specific to the first user, such as a user's name or email address. Thus, in order for a second user to redeem the electronic coupon, the information related to the first user must be removed from the electronic coupon code. When the “scrubbed” coupon is sent to the second user, the coupon server 125 would then enter the specific information related to the second user.

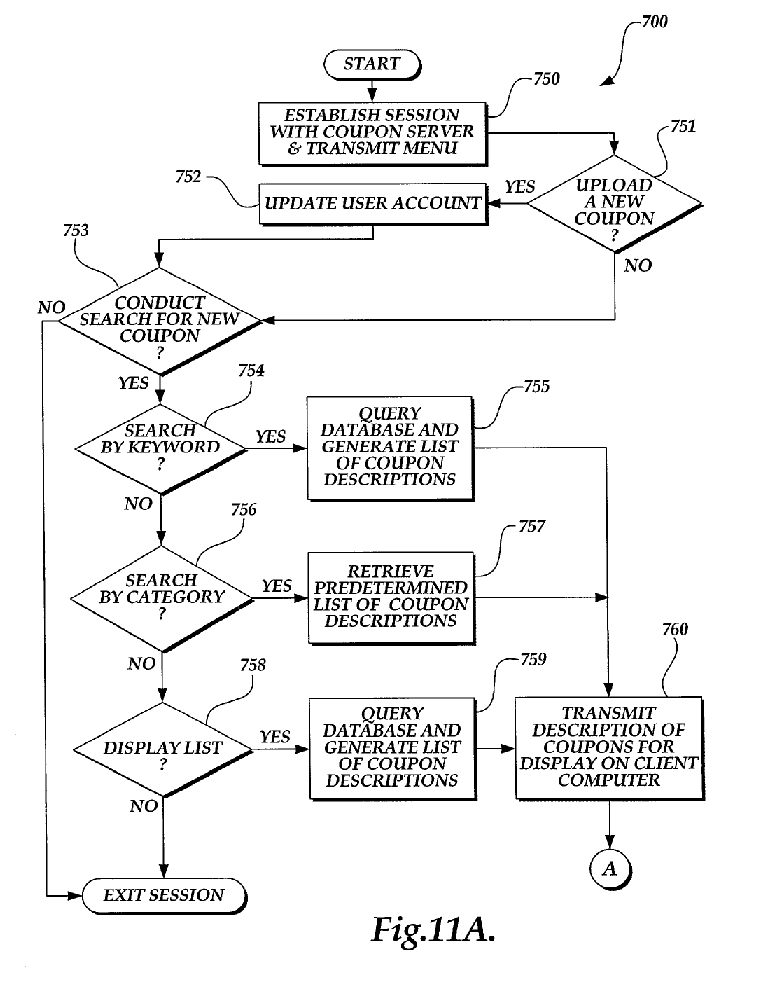

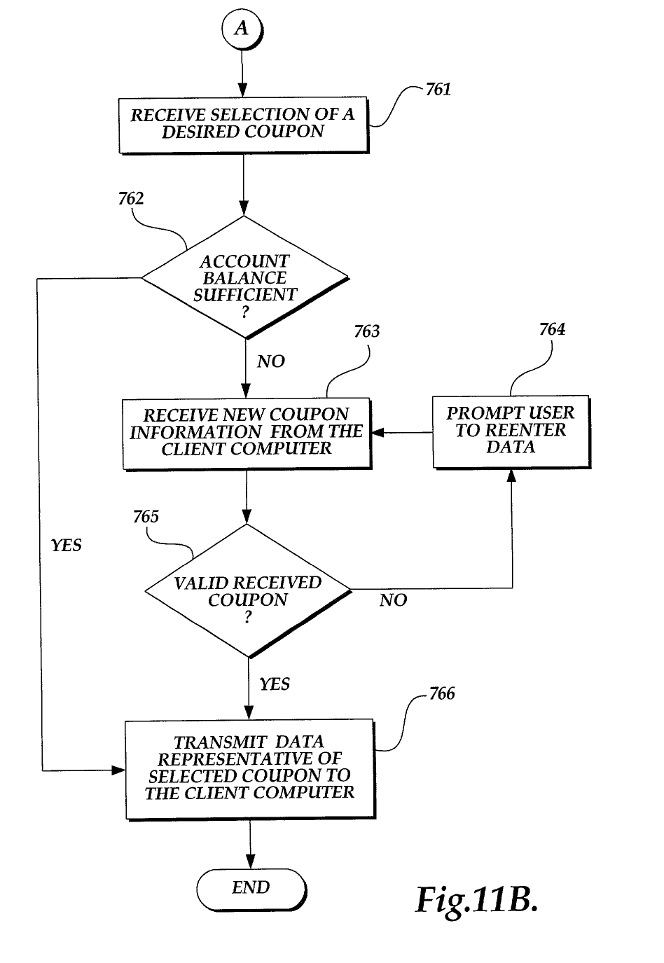

Referring now to FIGS. 11A-11B, in conjunction with the system illustrated in FIG. 1, an illustrative routine 700 for providing the above-described electronic coupon exchange formed in accordance with the present invention is shown and described. The routine 700 begins at block 750 where a Web browser application 256 executing on a client computer 120 establishes a communication link between the client computer 120 and the coupon server 125. In this part of the process, the communication link between the client computer 120 and the coupon server 125 may be in the form of a secured login where a user may have a login and password to access the Web server application 560 of the coupon server 125.

Although the above-described example illustrates an embodiment utilizing HTML Web pages it will be appreciated by one having ordinary skill in the art that any client computing device may be used to access a coupon server 125 by many other means of communication, such as instant messaging applications, paging systems, and cellular phone data communication channels, or the like. Once a communication session is established with the coupon server 125, the coupon server 125 transmits a Web page to the user for prompting the user to transmit a coupon to the coupon server 125 or search for an electronic coupon stored in the coupon database 465.

Next, as shown in decision block 751, the coupon server 125 determines if the user of the client computer 120 has submitted any electronic coupons to the coupon server 125. In this part of the process, the coupon server 125 determines if any coupon codes have been received from the client computer 120. This process can be implemented by a Web page similar to that shown in FIG. 7, where text entry fields 612, 613, and 614 are available for a user to transmit text codes back to the coupon server 125. If the coupon server 125 receives at least one code that represents an electronic coupon, the routine 700 then continues to blocks 752 where the coupon server 125 then credits the user's account based on the information received from the coupon code. In this part of the process, the coupon server 125 may also verify the validity of the received coupon codes. The method for verifying the validity of a coupon code is described above with reference to FIG. 9.

If, at decision block 751, the coupon server 125 does not receive any codes that represent an electronic coupon, the routine 700 proceeds to decision block 753 where the coupon server 125 determines if the user of the client computer 120 desires to search for a new electronic coupon. In this part of the process, the coupon server 125 can make this determination by receiving a URL string from the client computer 120 indicating the user's selection from a Web page. If, at decision block 753, the user indicates that they do not want to conduct a search for a new electronic coupon, the routine 700 terminates and the coupon server 125 then exits the network session with the client computer 120.

However, if at decision block 753, the coupon server 125 determines that the user wants to conduct a search for a new coupon, the routine 700 then proceeds to decision block 754, where the coupon server 125 determines if the user of the client computer 120 has selected a keyword search for locating a desired electronic coupon. As described above, with reference to FIG. 8, this part of the process can be carried out by the generation of a Web page having the necessary HTML code for transmitting the user desired option and a plurality of keywords from the client computer 120 to the coupon server 125.

If at decision block 754, the coupon server 125 receives a signal indicative of a keyword search, the routine 700 proceeds to block 756 where the coupon server 125 queries the coupon database 465 by the use of a character string comparison of words stored in the coupon database 465 and the keyword that is provided by the client computer 120. As known to one of ordinary skill in the art, any basic keyword search algorithm may be used to implement this part of the invention so long as the keyword search is sufficient for locating electronic coupons with some relation to the user provided keyword.

If, at decision block 754, the coupon database of the coupon server 125 does not receive a signal that indicates a keyword search, the routine 700 continues to decision block 756 where the coupon server 125 determines if a user of the client computer 120 desires to execute a search for an electronic coupon by a category search. As described above, with reference to FIG. 8, the coupon server 125 may receive a signal indicating a category search by the transmission of a uniform resource locator (URL) transmitted from the client computer 120 to the coupon server 125. The URL may be generated by an HTML-based Web page, such as the HTML Web page illustrated in FIG. 8.

If, at decision block 756, the coupon server 125 receives a signal indicating the execution of a category search, the routine 700 proceeds to block 757 where the coupon server 125 examines the information received from the client computer 120 to retrieve a list of electronic coupons. To implement this exemplary embodiment of category search, it is known by one of ordinary skill in the art that a category search may be executed by storing a plurality of electronic coupons into specified categories, then retrieving the database elements when a specified database category is queried. Known database applications may be used to facilitate this step. Thus, the process of block 757 involves a database query that retrieves a predetermined list of coupon descriptions from the coupon database 565.

If, at decision block 756, the coupon server 125 does not receive a signal indicating a category search, the routine 700 proceeds to decision block 758, where the coupon server 125 determines if a user of a client computer 120 has requested a database query to display all of the electronic coupons in the coupon database 565. If the coupon server 125 receives a signal indicative of a request to display all of the database elements, the routine 700 proceeds to block 759 where the coupon server 125 sends a query to the coupon database 565 to generate a list of all of the coupons in the coupon database 565. As known to one of ordinary skill in the art, open-ended database queries can be executed to retrieve a limited number of coupons, for example, a database query that may include all of the electronic coupons in a database only dating back to electronic coupons that have been stored for a time period of less than two weeks.

Referring back to decision block 758, if the coupon server 125 does not receive a signal indicating the execution of a desire to transmit a display list, the routine 700 terminates by terminating the session between the coupon server 125 and the client computer 120. As known to one of ordinary skill in the art, sessions established through sockets over the Internet may be manually terminated or terminated after a predetermined period of time.

As shown in FIG. 11A, after the coupon server 125 has made a database query from one of the process blocks 755, 757 or 759, the routine 700 proceeds to block 760 where the coupon server 125 transmits descriptions of each coupon found in the database query of processed blocks 755, 757, or 759. In this part of the process, the coupon server 125 generates the necessary HTML code for displaying the electronic coupon information on the client computer 120. As described above with reference to FIG. 9, this part of the process only involves the transmission of information that describes the electronic coupons found in the database query. For example, one electronic coupon that may be found in the database may be described as “10% discount from www.gap.com.”

After the coupon server 125 transmits the descriptions of the electronic coupons, the routine 700 then proceeds to block 761 FIG. 11B) where the coupon server 125 receives a signal that indicates a selection of a desired coupon. As described above, with reference to FIG. 8, the client computer 120 may transmit a signal describing a selected coupon by the use of a URL, CGI script, or any other like form of communication. After the coupon server 125 receives the selection of desired coupons from the user, the routine 700 then continues to decision block 762 where the coupon server 125 determines if the user has a sufficient balance in their account to download the selected electronic coupons. If, at decision block 762, the coupon server 125 determines that the user has a sufficient balance, the routine 700 then proceeds to block 766 where the coupon server 125 transmits the selected electronic coupons to the client computer 120.

If, at decision block 762, the coupon server 125 determines that the user does not have a sufficient balance, the routine 700 then proceeds to block 763 where the coupon server 125 receives electronic coupons from the user of the client computer 120. This part of the process can be implemented by a Web page such as the example shown in FIG. 9, where the user may provide a plurality of electronic coupon codes for submission to the coupon server 125. As described above, this part of the process involves the communication of a code that represents the electronic coupon, a description of the electronic coupon, an information regarding the honoring server of the communicated electronic coupon.

As shown in decision block 765, the routine 700 then verifies the validity of the received coupon. In this part of the process, the coupon server 125 may communicate with an honoring server 130 to verify the existence of the communicated coupon code. At decision block 765, if the coupon server 125 determines that the coupon code of the received coupon is not valid, the routine 700 then proceeds to block 764 where the coupon server 125 generates a Web page to prompt the user to reenter the coupon data. From block 764, the routine 700 then proceeds back to block 763 where the coupon server 125 receives the corrected data of the electronic coupon entered by the user of the client computer 120. The routine 700 loops through blocks 763-765 until the session times out or until a valid coupon code is received by the coupon server. At decision block 765, if the coupon server 125 determines that the coupon code for the received coupon is valid, the routine 700 then proceeds to block 766 where the coupon server 125 transmits the coupon code of the desired coupon to the client computer 120 for display to the user.

Once the user receives the coupon code from the coupon server 125, the user is able to use the received electronic coupon for the intended purpose. For example, if the received electronic coupon is in the form of a coupon code, the user would enter the received coupon code into an e-commerce web page, as shown in FIG. 6. In another example, if the electronic coupon is in the form of a URL, the user would access the web page of the corresponding URL received in the electronic coupon. In yet another example, if the electronic coupon is in the form of an image file, the user may print the electronic coupon and then redeem the coupon at the corresponding retail or commerce entity.

According to yet another actual embodiment of the present invention, the above-described electronic coupon aggregation and exchange methods are implemented on a networked peer computing environment. This embodiment of the present invention involves a decentralized server configuration where a plurality of peer computers are configured to function as client and server computers, and more specifically, each peer computer has the ability to locate and exchange electronic coupons in direct communication links with other peer computers. In this embodiment, a software application resident on a user's peer computer, also referred to as a client computer, allows a first user to present coupons for exchange with other users of remote peer computers running enabling software. Any user possessing an electronic coupon for exchange may exchange that coupon from the user's computer for a desired coupon resident on a remote peer computer. The invention enables the exchange of these coupons so that the desired coupon becomes resident on the user's computer and the coupon exchanged by the user becomes resident on a remote peer computer. A coupon thus exchanged may be utilized for purchases by the user of the computer upon which the coupon now resides. In the alternative, such a coupon may be further exchanged by the user in accordance with the teachings of the present invention.

For illustrative purposes, two implementations of a networked peer computing environment are disclosed in more detail below. The first implementation involves a peer computing environment having a semi-distributed database. This semi-distributed database implementation includes a plurality of client computers each storing a database of electronic coupons and a server computer that stores an index of electronic coupons stored on the client computers. One example of a software application that accommodates this computing environment is produced by Napster, Inc. of Redwood City, Calif. The second implementation of the networked peer computing environment involves a peer computing architecture having a fully-distributed database. This implementation includes a plurality of client computers each storing a database of electronic coupons and at least one host server storing the network address information of the client computers. Examples of several software applications that accommodate this computing environment are produced by FreePeers, Inc. of West Palm Beach, Fla. and FirstPeer, Inc. of Las Vegas, Nev.

Referring again to FIG. 1, an illustrative implementation of a peer computing environment having a semi-distributed database will be described. In summary, this embodiment allows users to store electronic coupons on each client computer 120, search for desired electronic coupons on a database stored on a coupon server 125, and retrieve selected electronic coupons from a remote peer computer. Generally described, the computing environment of this embodiment comprises a plurality of client computers 120 (also referred to as peer computers), a coupon server 125, an honoring server 130, and an issuing server 135. As described above, each computing device depicted in FIG. 1 is configured to electronically communicate via a network such as the Internet 101. In addition, the functionality of the honoring server 130 and the issuing server 135 are similar to that described above, where each device processes electronic coupons for allowing a user to receive and redeem electronic coupons.

Referring again to FIG. 2, an illustrative computer architecture for implementing a client computer 120 of the peer computing environment will be described. In this embodiment, the client computers 120 are generally constructed in a manner similar to the client computers configured for the above-described embodiments, and in addition, other features are present to accommodate the semi-distributed database configuration. The client computer 120 further comprises a coupon database 259 for storing electronic coupon codes and other necessary data attributes for accommodating various electronic coupon formats. The client computer 120 also comprises a software application, also referred to as a peer application 260, for communicating search data with the coupon server 125. In one embodiment, the software application resident on the client computer 120 is configured for allowing a user of the client computer 120 to enter and transmit database queries to the coupon server 125.

Referring again to FIG. 5, an illustrative computer architecture for implementing a coupon server 125 of the peer computing environment will be described. In this embodiment, the coupon server 125 is generally configured in a manner similar to the coupon server 125 described above with reference to FIG. 5. In addition, the coupon database 565 of the coupon server 125 is preferably configured to store a description of each electronic coupon stored in the electronic coupon databases 259 of each client computer 120. In this embodiment, it is preferred that the essential electronic coupon data, such as the coupon code or referencing coupon URL, is not stored in the coupon database 565 of the coupon server 125. In addition, the coupon database 565 is configured to store the location information, e.g., an IP address of a client computer, associated with each received electronic coupon. The coupon server 125 is also configured with a coupon exchange server application 600 for receiving database search queries from the client computers 120 and for executing a database search on the coupon database 565.

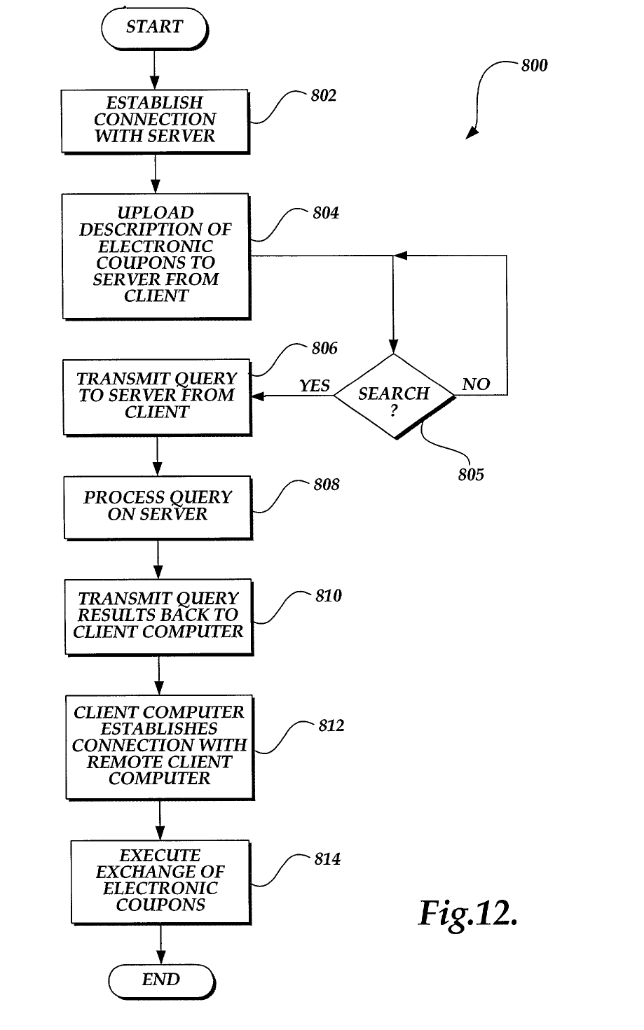

Referring now to FIG. 12, an illustrative routine 800 for providing a peer to peer coupon exchange on a semi-distributed database system is shown and described. The routine 800 begins at block 802 where the peer application 260 executing on a client computer 120 establishes a communication link between the client computer 120 and the coupon server 125. In this part of the process, the communication link established between the client computer 120 and the coupon server 125 may be in the form of a secured login where a user may have a login and password to access the coupon exchange server application 600 of the coupon server 125.

Once the peer application 260 establishes a communication link with the coupon exchange server application 600, the process continues to block 804 where the peer application 260 uploads a description of the electronic coupons stored in the coupon database 259 to the coupon database 565 of the coupon server 125. In this part of the process, it is preferred that the peer application 260 only provides a description of the electronic coupons stored in the coupon database 259 of the client computer 120. Once received, the coupon server 125 stores the description of each electronic coupon in the coupon database 565 and associates the network address of the client computer 120 with each electronic coupon description received by the client computer 120.

Next, as shown in decision block 805, the peer application 260 then determines if the user of the client computer 120 desires to execute a search. In this part of the process, the peer application 260 determines if the user of the client computer 120 has entered a search query. If no search query has been entered by the user, the peer application 260 remains in an idle state until a search query is received by the user. In this idle stage, the peer application 260 may be configured to retain its communication link with the coupon server 125 until the user manually terminates the peer application 260. Alternatively, at decision block 805, if the peer application 260 receives a search query from the user, the process then continues to block 806 where the peer application 260 transmits the query to the coupon exchange server application 600 of the coupon server 125.

As shown in block 808, in response to receiving the query, the coupon exchange server application 600 applies the query to a database search, thereby locating a plurality of electronic coupons stored in the coupon database 565 that match the parameters of the database query. As can be appreciated by one of ordinary skill in the art, the application of a database search query may be carried out in a variety of ways. In one example, text or string comparisons may be applied to locate one or more database elements that match the text provided in the database search query. As known to one of ordinary skill in the art, the execution of a database search produces a database query result which may be in the form of a text table or any other like data output.

Once the desired electronic coupons have been located by the coupon exchange server application 600, the process then continues to block 810 where the coupon exchange server 600 transmits the query results to the client computer 120. In the data transmission, it is preferred that the coupon exchange server application 600 transmit descriptions of the electronic coupons located in the query results. In addition, the coupon exchange server application 600 transmits the network address of each remote client computer storing the electronic coupons described in the query results. The peer application 260 then displays the database query results on the display 240 of the client computer 120. From the display of the query results, the user selects one or more of the electronic coupons.

Once the user selects a desired electronic coupon, the routine 800 then continues to block 812 where the peer application 260 executing on the client computer 120 establishes a network connection with the remote client computers storing the selected electronic coupons. Once the client computer 120 has established a network connection with the remote client computer, the routine 800 then continues to block 814 where the client computer 120 and remote client computer exchange electronic coupons. The exchange of electronic coupons between the client computers may be executed in a number of ways. For illustrative purposes, two different implementations of the exchange process of block 814 are described in more detail below. Generally described, one implementation of the electronic coupon exchange involves an automated rule-based exchange routine. Another implementation of the coupon exchange involves a manual user-controlled routine that allows a user to view and authorize each coupon exchange.

The first illustrative example of process of block 814 allows a first user of a client computer to exchange a first electronic coupon with the second user of a client computer for a second electronic coupon. To carry out the exchange, it is preferred that each user store at least one electronic coupon in their local client database. When a first user locates a desired electronic coupon (blocks 802-812) on the remote client computer of the second user, the first user offers his or her first electronic coupon to the second user in exchange for the selected electronic coupon stored on the second user's computer. In this embodiment, the first user offers his or her electronic coupon by selecting a plurality of electronic coupons stored in the first client computer database. Accordingly, when the client computer of the first user transmits a signal to indicate their selection of a desired electronic coupon on the second client computer, the first client computer also communicates the description of electronic coupons offered by the first user.

In response to receiving the electronic coupon information offered by the first user, the peer application 260 on the second client computer refers to a set of parameters established by the second user. For example, if the second user is looking for a specific type of electronic coupon, such as a 10% discount on items of a retail store, the second user can establish those parameters in the peer application 260. When the first user locates the electronic coupon offered by the second user, the second client computer only allows the first user's client computer to download the desired electronic coupon if the first user offers an electronic coupon that matches the parameters set by the second user.

The second illustrative example of process block 814 involves a user-controlled exchange process. In this embodiment, the peer application 260 is set in a manual mode where instant messages are generated for the user to select electronic coupons that are offered for an exchange. For example, if a first user locates a desired electronic coupon on the client computer of a second user, the client computer of the first user transmits a list of electronic coupons offered by the first user for display on the client computer of the second user. Upon the review of a display showing the list of coupons offered by the first user, the second user then selects one of the electronic coupons to execute the exchange of electronic coupons between the two users. As described above, the transfer of the electronic coupons involves the communication of the coupon code and/or a URL directed to an electronic coupon.

Similar to the embodiment of FIGS. 11A and 11B, the coupon exchange process of block 814 may also involve an electronic coupon validation process. This validation process is similar to the validation process described above with reference to blocks 763-766 of FIG. 11B. As described above, each client computer may access an electronic database of an honoring server 130 or an issuing server 135 to verify the validity of the received electronic coupons. Once the coupons are exchanged between the two users, the exchange routine 800 terminates.

Referring again to FIG. 1, an illustrated implementation of a peer computing environment having a fully-distributed database will be described. In summary, this embodiment allows users of client computers 120 to store electronic coupons on each client computer 120, search for electronic coupons on remote client computers by transmitting a plurality of search queries to other client computers, and retrieving desired electronic coupons directly from the other remote client computers. The computing environment of this embodiment comprises a plurality of client computers 120, an honoring server 130 and an issuing server 135. Similar to the embodiment of the semi-distributed database system, the functionality of the honoring server 130 and the issuing server 135 is similar to that as described above, where each device processes electronic coupons for allowing users to receive and redeem electronic coupons. However, in this embodiment, each client computer 120 is configured with a peer application 260 that allows each client computer 120 to function as a host, server and/or a client computer. In addition to storing the electronic coupons, the coupon database 259 of each client computer 120 also stores a plurality of network addresses for other peer or remote client computers. As can be appreciated by one of ordinary skill in the art, this configuration of a peer application 260 can be associated with the Gnutella model.

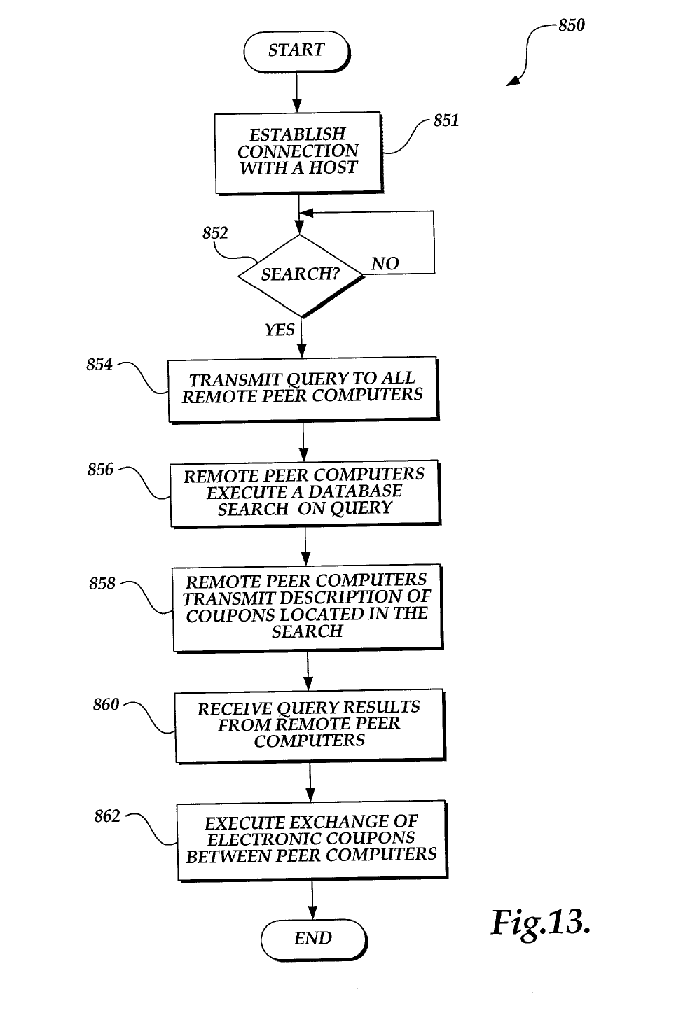

Referring now to FIG. 13, in conjunction with the system illustrated in FIG. 1, an illustrative routine 850 for providing a peer to peer coupon exchange on a fully-distributed database system is shown and described. The routine begins at block 851 where the peer application 260 executing on a client computer 120 establishes a communication link with a host to receive a plurality of peer network addresses from the hose. In this embodiment, a host may be any server (125-135) or client computer 120 connected to the Internet 101. Generally described, a host computer is configured with a software application for storing and distributing a plurality of network addresses to other client computers. As can be appreciated by one of ordinary skill in the art, network addresses collected by a host in the Gnutella model are provided by client computers of users who desire to join a trading group. In the process of block 851, the communication link established between the client computer 120 and the host may be in the form of a secure login or any other network connection sufficient for the transfer of at least one network address of computers having peer application 260 software. Accordingly, all other client computers having a peer application 260 for connection with the client computer 120 is considered to be a “peer computer” in the trading group.

Once the client computer 120 receives all of the network addresses of other peers in the trading group, the routine 851 proceeds to a decision block 852 where the client computer then determines if the user of the client computer 120 desires to execute a search. Similar to the embodiment described above, the peer application 260 determines if the user of a client computer 120 has entered a search query. If no search query has been entered by the user, the peer application 260 remains in an idle state until a search query is received or until the user terminates the peer application 260. When the peer application 260 receives a search query, the process then continues to block 854 where the client computer 120 then broadcasts the search query to the remote peer computers in the trading group.

Next, at block 856, each remote peer computer that receives the search query executes a database search on its local database to locate electronic coupons that match the parameters of the search query. Once the remote peer computers execute the database search, the process then continues to block 858 where the remote peer computers transmit their search results back to the client computer 120. In this embodiment, it is preferred that each remote peer computer only transmit a description of each electronic coupon found in the database search results.

The process then continues to block 860 where the originating client computer 120 receives the search results from the peer computers and displays the results to the user of the client computer 120. As described above with reference to process block 810, the user of the client computer then selects a desired coupon from the electronic coupons of the search results. The process then continues to block 862 where the client computer 120 then establishes a network connection with the remote peer computer storing the selected electronic coupon. As shown in block 862, the client computer 120 and the selected peer computer then execute an exchange of electronic coupons. The process of block 862 is executed in a manner similar to the process of block 814 of FIG. 12. Once the exchange process of block 862 is complete, the routine 850 terminates.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for providing a computer-based forum for exchanging electronic coupons, the method comprising:
providing a forum database of a plurality of electronic coupons;
transmitting a description of at least one first electronic coupon from the forum to a client computer;
receiving by the forum a signal indicative of a client selection of the at least one first electronic coupon; and
in response to the signal, performing an exchange of electronic coupons, wherein the exchange includes the receipt by the forum from the client computer of data representing a second electronic coupon in trade for the receipt at the client computer of data representing the first electronic coupon.

2. The method of claim 1 further comprising, verifying the validity of the second electronic coupon.

3. The method of claim 2, wherein verifying the validity of the second electronic coupon comprises:
transmitting data related to the second electronic coupon to an issuing server; and
receiving a response from said issuing server indicating whether the validity of the second electronic coupon.

4. The method of claim 2, wherein verifying the validity of the second electronic coupon comprises, comparing the second electronic coupon to a valid electronic coupon stored in a coupon database.

5. The method of claim 1, further comprising, removing user data from the second electronic coupon.

6. The method of claim 1, further comprising:
determining whether to exchange the at least one first electronic coupon for the second electronic coupon; and
if a determination is made to exchange, performing an exchange of electronic coupons, wherein the exchange includes the receipt by the forum of data representing the second electronic coupon in trade for data representing the first electronic coupon.

7. A method for providing a computer-based forum for exchanging electronic coupons, the method comprising:
storing a plurality of electronic coupons on a server;
transmitting a description of at least one first electronic coupon from the server to a client computer;
receiving a signal indicative of a client selection of the at least one first electronic coupon; and
in response to the signal, performing an exchange of electronic coupons, wherein the exchange includes the receipt by the server from the client computer of data representing a second electronic coupon in trade for a transmission from the server of data representing the first electronic coupon.

8. The method of claim 7 further comprising, verifying the validity of the second electronic coupon.

9. The method of claim 8, wherein verifying the validity of the second electronic coupon comprises:
transmitting data related to the second electronic coupon to an issuing server; and
receiving a response from said issuing server indicating whether the validity of the second electronic coupon.

10. The method of claim 8, wherein verifying the validity of the second electronic coupon comprises, comparing the second electronic coupon to a valid electronic coupon stored in a coupon database.

11. The method of claim 7, further comprising, removing user data from the second electronic coupon.

12. The method of claim 7, further comprising:
determining whether to exchange the at least one first electronic coupon for the second electronic coupon; and
if a determination is made to exchange, performing an exchange of electronic coupons, wherein the exchange includes the receipt by the forum of data representing the second electronic coupon in trade for data representing the first electronic coupon.

13. A method for providing a computer-based forum for exchanging electronic coupons, the method comprising:
providing a database of a plurality of electronic coupons resident on and available for download from at least one first peer computer;
transmitting a description of at least one first electronic coupon from the database to a second peer computer;
receiving by the first peer computer on which the first electronic coupon resides, a signal indicative of a client selection of the at least one first electronic coupon; and
in response to the signal, performing an exchange of electronic coupons, wherein the exchange includes the receipt by the first peer computer from the second peer computer of data representing a second electronic coupon in trade for the receipt at the second peer computer of data representing the first electronic coupon.

14. The method of claim 13 further comprising, verifying the validity of the second electronic coupon.

15. The method of claim 14, wherein verifying the validity of the second electronic coupon comprises:
transmitting data related to the second electronic coupon to an issuing server; and
receiving a response from said issuing server indicating whether the validity of the second electronic coupon.

16. The method of claim 14, wherein verifying the validity of the second electronic coupon comprises, comparing the second electronic coupon to a valid electronic coupon stored in a coupon database.

17. The method of claim 13, further comprising, removing user data from the second electronic coupon.

18. The method of claim 13, further comprising:
determining whether to exchange the at least one first electronic coupon for the second electronic coupon; and
if a determination is made to exchange, performing an exchange of electronic coupons, wherein the exchange includes the receipt by the forum of data representing the second electronic coupon in trade for data representing the first electronic coupon.

19. A computer-readable medium having an executable component for providing a computer-based forum for exchanging electronic coupons, wherein the executable component performs a method comprising:
providing a forum database of a plurality of electronic coupons;
transmitting a description of at least one first electronic coupon from the forum to a client computer;
receiving by the forum a signal indicative of a client selection of the at least one first electronic coupon; and
in response to the signal, performing an exchange of electronic coupons, wherein the exchange includes the receipt by the forum from the client computer of data representing a second electronic coupon in trade for the receipt at the client computer of data representing the first electronic coupon.

20. The computer readable medium of claim 19, where the computer-readable medium having an executable component further comprising the step of, verifying the validity of the second electronic coupon.

21. A computer-readable medium having an executable component for electronic coupon exchange services, wherein the executable component performs a method comprising:
providing an electronic exchange, wherein the system comprises:
storing a plurality of electronic coupons on a server;
transmitting a description of at least one first electronic coupon from the server to a client computer;
receiving a signal indicative of a client selection of the at least one first electronic coupon; and
in response to the signal, performing an exchange of electronic coupons, wherein the exchange includes the receipt by the server from the client computer of data representing a second electronic coupon in trade for a transmission from the server of data representing the first electronic coupon.

22. The computer readable medium of claim 21, where the computer-readable medium having an executable component further comprising the step of, verifying the validity of the second electronic coupon.

23. A system for providing an electronic exchange, wherein the system comprises:
a coupon server;
an issuing server;
an honoring server, wherein the coupon server, honoring server and the issuing server are electronically connected via a network for communicating data representative of an electronic coupon, and wherein the coupon server comprises a computer-readable medium having an executable component for providing a computer-based forum for exchanging electronic coupons, wherein the executable component comprises:
providing a forum database of a plurality of electronic coupons;
transmitting a description of at least one first electronic coupon from the forum to a client computer;
receiving by the forum a signal indicative of a client selection of the at least one first electronic coupon; and
in response to the signal, performing an exchange of electronic coupons, wherein the exchange includes the receipt by the forum from the client computer of data representing a second electronic coupon in trade for the receipt at the client computer of data representing the first electronic coupon.

24. A method for providing a computer-based forum for exchanging electronic coupons, the method comprising:
providing a forum database of a plurality of electronic coupons;
transmitting a description of at least one first electronic coupon from the forum to a client computer;
receiving by the forum a signal indicative of a client offer to exchange a second electronic coupon for the at least one first electronic coupon;
determining whether to exchange the at least one first electronic coupon for the second electronic coupon; and
if a determination is made to exchange, performing an exchange of electronic coupons, wherein the exchange includes the receipt by the forum of data representing the second electronic coupon in trade for data representing the first electronic coupon.

25. The method of claim 24 wherein said step of determining whether to exchange comprises verifying the validity of the second electronic coupon.

26. The method of claim 25 wherein verifying the validity of the second electronic coupon comprises:
transmitting data related to the second electronic coupon to an issuing server; and
receiving a response from said issuing server indicating whether the second electronic coupon is valid.

27. The method of claim 25, wherein verifying the validity of the second electronic coupon comprises:
transmitting data related to the second electronic coupon to an honoring server; and
receiving a response from said honoring server indicating whether the second electronic coupon is valid.

28. The method of claim 24, wherein determining whether to exchange comprises comparing the second electronic coupon to a valid electronic coupon stored in a coupon database.
